(19) United States
(12) Patent Application Publication
(10) Pub. No.: US 2024/0320536 A1
(43) Pub. Date: Sep. 26, 2024

(54) HANDLING BLACK SWAN EVENTS ON QUANTUM COMPUTERS

(71) Applicant: International Business Machines Corporation, Armonk, NY (US)

(72) Inventors: Arkadiy O. Tsfasman, Wappingers Falls, NY (US); Vladimir Rastunkov, Mundelein, IL (US); Frederik Frank Flöther, Schlieren (CH); John S. Werner, Fishkill, NY (US)

(21) Appl. No.: 18/126,473

(22) Filed: Mar. 26, 2023

(51) Int. Cl. G06N 10/70; G06N 10/20

(52) U.S. Cl. CPC G06N 10/70; G06N 10/20

(57) ABSTRACT

A method, system, and computer program product for handling black swan events on a quantum computing device. Sensor data from an environment of the quantum computing device is captured and compared to historical sensor data of the environment of the quantum computing device. A black swan event is detected if the difference between the captured sensor data and the historical sensor data exceeds a threshold value. Upon detecting a black swan event, such as during the time that the quantum processor is being utilized, a machine learning model is executed to identify the action to be performed to handle the black swan event. The machine learning model identifies such an action based on identifying a neuron of a self-organizing map that most closely matches the captured sensor data, and then identifying which of the clusters of data within the identified neuron is closest to the captured sensor data.

### TECHNICAL FIELD

The present disclosure relates generally to noisy intermediate-scale quantum (NISQ) devices, and more particularly to handling black swan events on quantum computers.

### BACKGROUND

The current state of quantum computing is referred to as the noisy intermediate-scale quantum (NISQ) era, characterized by quantum processors containing tens, hundreds, or thousands of qubits which are not yet advanced enough for fault-tolerance or quantum advantages in production uses. These processors, which are sensitive to their environment (noisy) and prone to quantum decoherence, are not yet capable of continuous quantum error correction. This intermediate-scale is defined by the quantum volume, which is based on the moderate number of qubits and gate fidelity.

NISQ algorithms are designed for quantum processors in the NISQ era, such as the variational quantum eigensolver (VQE) and quantum approximate optimization algorithm (QAOA). These algorithms have been explored in quantum chemistry, machine learning, and optimization and have potential applications in various fields including physics, material science, data science, cryptography, biology, and finance. However, they often require error mitigation or suppression techniques to produce accurate results.

Examples of such error mitigation or suppression techniques include learning the noise fingerprint of quantum devices, learning the quantum noise, learning to optimize the quantum circuits in the presence of noise, using machine learning to reconstruct the noise spectrum and identify sources of error, etc.

Unfortunately, such error mitigation and suppression techniques fail to dynamically handle black swan events. A “black swan event,” refers to external environmental conditions that may impact the operation and/or performance of the quantum computer. Examples of black swan events include vibrations from a data center computer room air condition unit, vibrations from other information technology equipment within a data center, audible sound vibrations from a fire alarm in the building, users accidentally bumping into the quantum computing system, pressure changes, temperature changes, humidity changes, solar flares, radiation events, etc.

The duration of such black swan events may exceed by many orders of magnitude the typical gate or circuit time thereby impacting many quantum circuit executions.

Unfortunately, there is not currently a means for handling such black swan events on a quantum computing device.

### SUMMARY

In one embodiment of the present disclosure, a method for handling black swan events on a quantum computing device comprises capturing sensor data from an environment of the quantum computing device. The method further comprises comparing the captured sensor data to historical sensor data of the environment of the quantum computing device. The method additionally comprises detecting a black swan event in response to a difference between the captured sensor data and the historical sensor data exceeding a threshold value. Furthermore, the method comprises performing an action to handle the black swan event.

Additionally, in one embodiment of the present disclosure, the action comprises one of the following in the group consisting of dynamically increasing a number of shots performed on a current operation, pausing the current operation and waiting for the black swan event to end, repeating a latest operation or a set of operations, dynamically adjusting quantum circuits to shorten their depth, and executing a different quantum model.

Furthermore, in one embodiment of the present disclosure, the method additionally comprises comparing the captured sensor data to the historical sensor data of the environment of the quantum computing device stored in a profile, where the profile comprises a self-organizing map of neurons, and where each of the neurons represents environmental conditions experienced within a physical environment.

Additionally, in one embodiment of the present disclosure, each of the neurons contains clusters of data, where each of the clusters of data is associated with an action in positively handling the black swan event, and where the method further comprises identifying a neuron of the neurons of the self-organizing map of neurons that most closely matches the captured sensor data. Furthermore, the method comprises determining which of the clusters of data of the identified neuron is closest to the captured sensor data. Additionally, the method comprises performing the action to handle the black swan event based on an action associated with the closest cluster of data.

Furthermore, in one embodiment of the present disclosure, the sensor data comprises one of the following in the group consisting of sound, pressure, temperature, humidity, vibration, and radiation.

Additionally, in one embodiment of the present disclosure, the method further comprises determining whether a quantum processor was being utilized at a same time as the black swan event. Furthermore, the method comprises executing a machine learning model to identify the action to be performed to handle the black swan event in response to the quantum processor being utilized at the same time as the black swan event. Additionally, the method comprises receiving user feedback regarding the identified action to be performed to handle the black swan event. In addition, the method comprises updating the machine learning model based on the received user feedback.

Furthermore, in one embodiment of the present disclosure, the black swan event comprises one or more of the following in the group consisting of vibrations, sounds, pressure changes, temperature changes, humidity changes, solar flares, and radiation events.

Other forms of the embodiments of the method described above are in a system and in a computer program product.

Accordingly, embodiments of the present disclosure effectively handle black swan events on a quantum computing device.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the internal structure of the quantum computing device in accordance with an embodiment of the present disclosure;

FIG. 3 illustrates an embodiment of the present disclosure of the hardware configuration of the room temperature electronics system which is representative of a hardware environment for practicing the present disclosure;

FIG. 4 is a flowchart of a method for handling black swan events that occur during execution of the quantum processor in accordance with an embodiment of the present disclosure;

FIG. 5 is a flowchart of a method for identifying the action to be performed to handle the black swan event in accordance with an embodiment of the present disclosure;

FIG. 6 illustrates a self-organizing map of neurons, where each neuron represents environmental conditions experienced by the quantum computing device, in accordance with an embodiment of the present disclosure; and

FIG. 7 illustrates a cluster model contained within a neuron of the self-organizing map of neurons in accordance with an embodiment of the present disclosure.

### DETAILED DESCRIPTION

As stated in the Background section, NISQ algorithms are designed for quantum processors in the NISQ era, such as the variational quantum eigensolver (VQE) and quantum approximate optimization algorithm (QAOA). These algorithms have been explored in quantum chemistry, machine learning, and optimization and have potential applications in various fields including physics, material science, data science, cryptography, biology, and finance. However, they often require error mitigation or suppression techniques to produce accurate results.

Examples of such error mitigation or suppression techniques include learning the noise fingerprint of quantum devices, learning the quantum noise, learning to optimize the quantum circuits in the presence of noise, using machine learning to reconstruct the noise spectrum and identify sources of error, etc.

Unfortunately, such error mitigation and suppression techniques fail to dynamically handle black swan events. A “black swan event,” refers to external environmental conditions that may impact the operation and/or performance of the quantum computer. Examples of black swan events include vibrations from a data center computer room air condition unit, vibrations from other information technology equipment within a data center, audible sound vibrations from a fire alarm in the building, users accidentally bumping into the quantum computing system, pressure changes, temperature changes, humidity changes, solar flares, radiation events, etc.

The duration of such black swan events may exceed by many orders of magnitude the typical gate or circuit time thereby impacting many quantum circuit executions.

Unfortunately, there is not currently a means for handling such black swan events on a quantum computing device.

The embodiments of the present disclosure provide the means for handling such black swan events on a quantum computing device. In one embodiment of the present disclosure, sensor data (e.g., sound, pressure, temperature, humidity, vibration, radiation, etc.) from an environment of the quantum computing device is captured and compared to historical sensor data of the environment of the quantum computing device. A black swan event may then be detected based on the difference between the captured sensor data and the historical sensor data exceeding a threshold value. A “black swan event,” as used herein, refers to external environmental conditions that may impact the operation and/or performance of the quantum computer. Examples of black swan events include vibrations from a data center computer room air condition unit, audible sound vibrations from a fire alarm in the building, users accidentally bumping into the quantum computing system, pressure changes, temperature changes, humidity changes, solar flares, radiation events, etc. Upon detecting a black swan event occurring, a classical machine learning model (referred to herein as the “classical black swan machine learning model”) is executed to identify an action to be performed to handle the black swan event. In one embodiment, such an action may be identified by identifying a neuron of a self-organizing map that most closely matches the captured sensor data. A “self-organizing map,” as used herein, refers to an unsupervised machine learning technique used to produce a low-dimensional (typically two-dimensional) representation of a higher dimensional data set while preserving the topological structure of the data. In one embodiment, such a self-organizing map includes neurons or nodes, which are arranged as a hexagonal or rectangular grid with two dimensions. In one embodiment, each neuron represents an environmental condition experienced within the physical environment of the quantum computing device. Upon identifying a neuron that most closely matches the captured sensor data, it is determined which of the clusters of data within the neuron is closest to the captured sensor data. In one embodiment, each neuron contains clusters of data, where each cluster of data is associated with an action in positively handling the black swan event. After identifying the cluster of data that is closest to the captured sensor data, an action to handle the black swan event is performed based on the action associated with the closest cluster of data. These and other features will be discussed in greater detail below.

In some embodiments of the present disclosure, the present disclosure comprises a method, system, and computer program product for handling black swan events on a quantum computing device. In one embodiment of the present disclosure, sensor data (e.g., sound, pressure, temperature, humidity, vibration, radiation, etc.) from an environment of the quantum computing device is captured and compared to historical sensor data of the environment of the quantum computing device. In one embodiment, a black swan event is detected based on comparing the captured sensor data from the environment of the quantum computing device with the historical sensor data stored in a self-organizing map of neurons, where each of the neurons represents environmental conditions experienced within the physical environment of the quantum computing device. A “self-organizing map,” as used herein, refers to an unsupervised machine learning technique used to produce a low-dimensional (typically two-dimensional) representation of a higher dimensional data set while preserving the topological structure of the data. In one embodiment, such a self-organizing map includes neurons or nodes, which are arranged as a hexagonal or rectangular grid with two dimensions. If the difference between the value(s) of the captured sensor data for a particular type of sensor data (e.g., pressure) with the neuron representing the value(s) of the historical environmental condition for the same type of sensor data (e.g., pressure) exceeds a user-designated threshold value, then a black swan event may be said to occur. Upon detecting a black swan event, such as during the time that the quantum processor is being utilized, a machine learning model (referred to herein as the “classical black swan machine learning model”) is executed to identify the action to be performed to handle the black swan event. In one embodiment, the classical black swan machine learning model identifies the action to be performed to handle the black swan event based on identifying a neuron of the self-organizing map that most closely matches the captured sensor data, and then identifying which of the clusters of data within the neuron is closest to the captured sensor data. In one embodiment, each neuron contains clusters of data, where each cluster of data is associated with an action in positively handling the black swan event. After identifying the cluster of data that is closest to the captured sensor data, an action to handle the black swan event is performed based on the action associated with the closest cluster of data. In this manner, black swan events involving quantum computing devices can be effectively handled.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

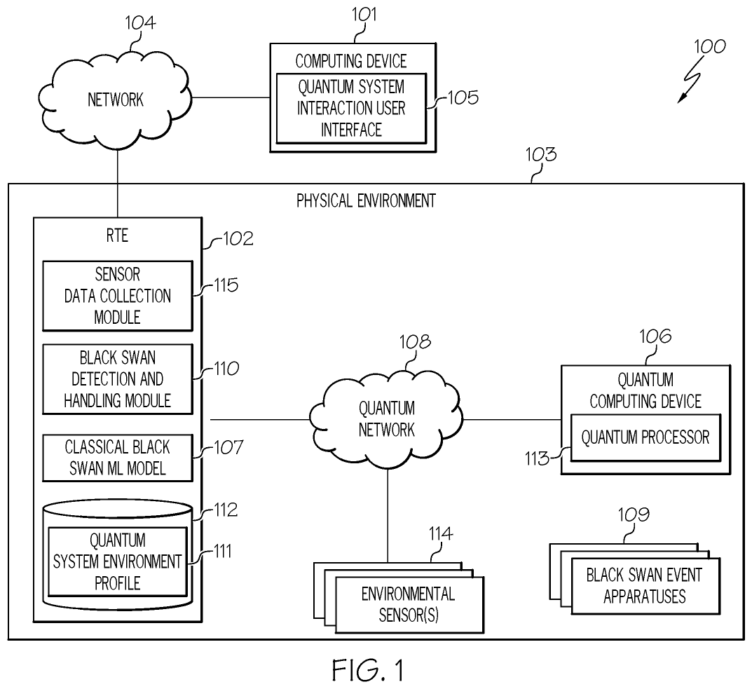

Referring now to the Figures in detail, FIG. 1 illustrates an embodiment of the present disclosure of a communication system 100 for practicing the principles of the present disclosure. Communication system 100 includes a computing device 101 connected to a room temperature electronics (RTE) system 102 in a physical environment 103 via a network 104.

In one embodiment, computing device 101 corresponds to a classical computer in which information is stored in bits that are represented logically by either a 0 (off) or a 1 (on). Examples of computing device 101 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 104.

Furthermore, in one embodiment, computing device 101 includes a quantum system interaction user interface 105 configured to enable the user of computing device 101 to interact with a quantum computing device 106 in physical environment 103 as discussed further below. In one embodiment, quantum system interaction user interface 105 enables the user of computing device 101 to upload a program/model to quantum computing device 106, obtain results, receive notification of a black swan noise event from room temperature electronics system 102 during program/model execution, and provide supervise learning input to the classical black swan machine learning model 107 as discussed further below.

Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network and various combinations thereof. Other networks, whose descriptions are omitted here for brevity, may also be used in conjunction with system 100 of FIG. 1 without departing from the scope of the present disclosure.

Furthermore, as shown in FIG. 1, physical environment 103 (surroundings and conditions where quantum computing is performed) includes room temperature electronics system 102 and quantum computing device 106 interconnected via a quantum network 108. Additionally, as shown in FIG. 1, physical environment 103 includes black swan event apparatuses 109. “Black swan event apparatuses 109,” as used herein, refer to potential sources of black swan events. For example, black swan event apparatuses 109, include, but are not limited to, other quantum systems, such as quantum computing device 106, classical systems, such as computing device 101, computer room air conditioning units, people, cell phones, forklifts, etc.

Referring again to FIG. 1, quantum network 108 facilitates the transmission of information in the form of quantum bits, also called qubits, between physically separated systems, devices, quantum processors, etc. While the following discusses the present disclosure in connection with qubits, the principles of the present disclosure apply to any type of qudit (unit of quantum information described by a superposition of d states, where the number of states is an integer greater than two). A person of ordinary skill in the art would be capable of applying the principles of the present disclosure to such implementations. Furthermore, embodiments applying the principles of the present disclosure to such implementations would fall within the scope of the present disclosure.

Furthermore, as shown in FIG. 1, room temperature electronics system 102 includes a black swan detection and handling module 110, a classical black swan machine learning model 107 and a quantum system environment profile 111 stored in a storage unit 112 of room temperature electronics system 102. In one embodiment, room temperature electronics system 102 corresponds to a classical computer. In one embodiment, room temperature electronics system 102 is configured to handle black swan events on quantum computing device 106, including quantum processor 113.

In one embodiment, the components (black swan detection and handling module 110, classical black swan machine learning model 107 and quantum system environment profile 111) of room temperature electronics system 102 may be executed on other classical hardware within physical environment 103 or on other hardware in a cloud computing environment connected through network 104 (e.g., cloud network) and/or quantum network 108.

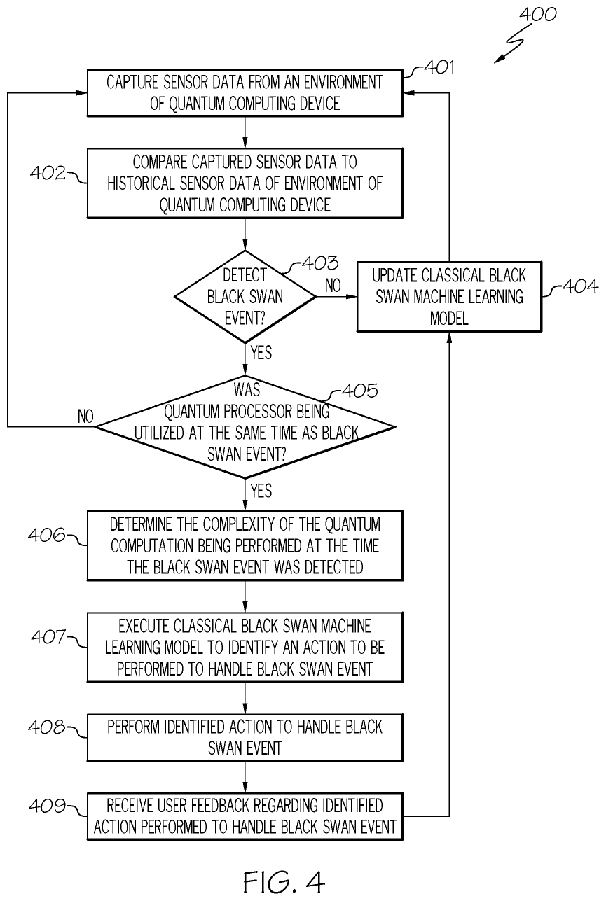

In one embodiment, black swan detection and handling module 110 compares the sensor data of the environment of quantum computing device 106 obtained from environmental sensors 114 (discussed further below) with the historical sensor data of the environment of quantum computing device 106 to determine if there is a difference. If the difference exceeds a threshold value, then a black swan may be deemed detected. Furthermore, in one embodiment, black swan detection and handling module 110 utilizes the classical black swan machine learning model 107 to determine what action to perform in response to a black swan event occurring during the usage of quantum processor 113 of quantum computing device 106. A further discussion regarding black swan detection and handling module 110 is provided below in connection with FIGS. 4-7.

In one embodiment, classical black swan machine learning model 107 is trained to generate an output (identify action to be performed to handle the black swan event) based on various inputs, such as quantum system environment profile 111, different black swan events and the complexity of the quantum computation being performed during the occurrence of the black swan event. Other examples of inputs to classical black swan machine learning model 107 to generate an output (identify action to be performed to handle the black swan event) include the performance of quantum processor 113, noise experienced by quantum processor 113, environmental data from environmental sensors 114, etc. A “black swan event,” as used herein, refers to external environmental conditions that may impact the operation and/or performance of the quantum computer. Examples of black swan events include vibrations, sounds, pressure changes, temperature changes, humidity changes, solar flares, radiation events, etc. A further discussion regarding classical black swan machine learning model 107 is provided below in connection with FIGS. 4-7.

In one embodiment, quantum system environment profile 111 contains data from environmental sensor(s) 114 connected to quantum network 108. Environmental sensors 114 are used to monitor the environment around quantum computing device 106, including the environment around quantum processor 113. Such sensor data (e.g., pressure, temperature, humidity, etc.) pertaining to the environment around quantum computing device 106, including the environment around quantum processor 113, is later captured by sensor data collection module 115 of room temperature electronics system 102. In one embodiment, sensor data collection module 115 captures the sensor data from environmental sensors 114 using various software tools, including, but not limited to, Data Capture Lab, etc. Examples of environmental sensors 114 include, but are not limited to, microphones (e.g., Sennheiser® EW 112P G3-A), vibration sensors (e.g., DX-VBR by Raritan®), pressure sensors (e.g., differential air pressure sensor), temperature sensors (e.g., DX2-T1 by Raritan®), humidity sensors (e.g., DX2-T1H1 by Raritan®), radiation sensors (e.g., Reed R8008 radiation meter), etc.

In one embodiment, quantum system environment profile 111 stores the historical sensor data of the environment of quantum computing device 106. For example, quantum system environment profile 111 stores the typical system vibration across a frequency range. In another example, quantum system environment profile 111 stores the typical sound profile across a frequency range. In a further example, quantum system environment profile 111 stores the typical radiation exposure. In one embodiment, such historical sensor data of the environment of quantum computing device 106 is stored in quantum system environment profile 111 by an expert based on environmental data captured by environmental sensors 114.

In one embodiment, such historical sensor data of the environment of quantum computing device 106 in profile 111 is stored in a self-organizing map of neurons as discussed in further detail below.

In one embodiment, room temperature electronics system 102 utilizes various software tools for sensor data analysis, such as analyzing the environmental data of quantum computing device 106 that was captured by environmental sensors 114. Such an analysis may involve identifying the average or typical measurement of the sensor data (e.g., humidity) thereby becoming the historical average for such a measurement. Examples of such software tools, include, but are not limited to, VibrationData Toolbox, enDAQ® lab, Sample Magic® Magic AB, Netmon, Sunbird®, FASTRAD®, etc.

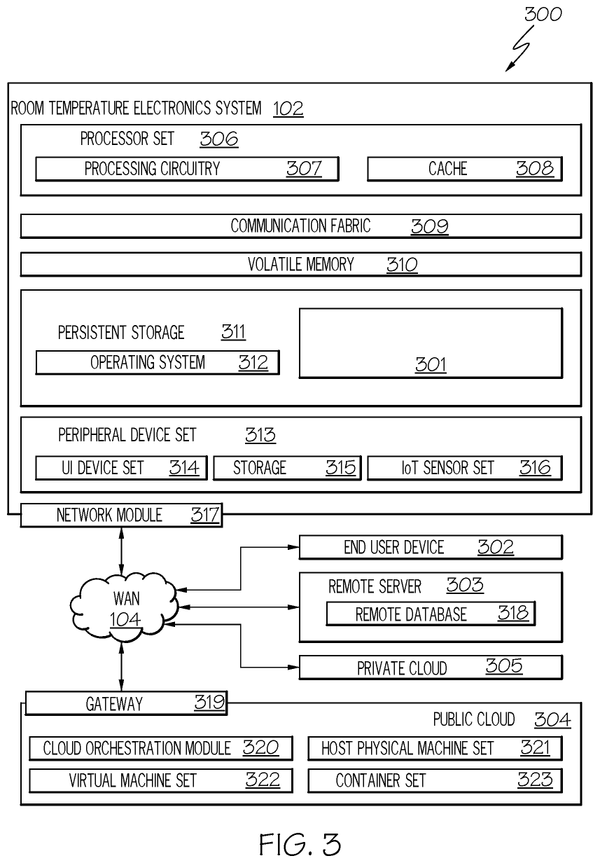

A description of the hardware configuration of room temperature electronics system 102 is provided further below in connection with FIG. 3.

Furthermore, as shown in FIG. 1, quantum computing device 106 includes quantum processor 113, which performs quantum computations. As previously discussed, quantum processor 113 is susceptible to black swan events which could impact performance. As previously discussed, room temperature electronics system 102 is configured to handle black swan events on quantum computing device 106, including quantum processor 113. In one embodiment, room temperature electronics system 102 is configured to perform an action to handle such a black swan event that is occurring while quantum processor 113 is in use, where such an action is based, at least in part, upon the complexity/nature of the computation being performed by quantum processor 113. In one embodiment, the process discussed herein for handling black swan events on quantum computing devices, such as quantum computing device 106, is applied both during the training and inference stage.

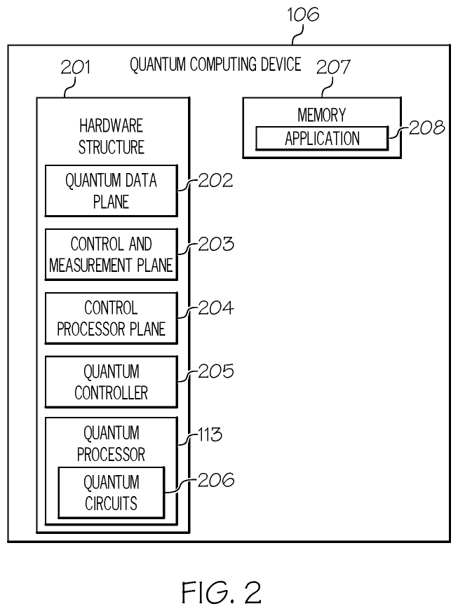

A description of the internal structure of quantum computing device 106 is provided below in connection with FIG. 2. In one embodiment, such an internal structure as depicted in FIG. 2 may also reside within both room temperature electronics system 102 and quantum computing device 106.

Referring now to FIG. 2, FIG. 2 illustrates the internal structure of quantum computing device 106 in accordance with an embodiment of the present disclosure.

In one embodiment, a hardware structure 201 of quantum computing device 106 includes a quantum data plane 202, a control and measurement plane 203, a control processor plane 204, a quantum controller 205 and a quantum processor 113.

Quantum data plane 202 includes the physical qubits or quantum bits (basic unit of quantum information in which a qubit is a two-state (or two-level) quantum-mechanical system) and the structures needed to hold them in place. In one embodiment, quantum data plane 202 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 202 provides a programmable “wiring” network that enables two or more qubits to interact.

Control and measurement plane 203 converts the digital signals of quantum controller 205, which indicates what quantum operations are to be performed, to the analog control signals needed to perform the operations on the qubits in quantum data plane 202. In one embodiment, control and measurement plane 203 converts the analog output of the measurements of qubits in quantum data plane 202 to classical binary data that quantum controller 205 can handle.

Control processor plane 204 identifies and triggers the sequence of quantum gate operations and measurements (which are subsequently carried out by control and measurement plane 203 on quantum data plane 202). These sequences execute the program, provided by quantum processor 113, for implementing a quantum algorithm.

In one embodiment, control processor plane 204 runs the quantum error correction algorithm (if quantum computing device 106 is error corrected).

In one embodiment, quantum processor 113 uses qubits to perform computational tasks. In the particular realms where quantum mechanics operate, particles of matter can exist in multiple states, such as an “on” state, an “off” state and both “on” and “off” states simultaneously. Quantum processor 113 harnesses these quantum states of matter to output signals that are usable in data computing.

In one embodiment, quantum processor 113 performs algorithms which conventional processors are incapable of performing efficiently.

In one embodiment, quantum processor 113 includes one or more quantum circuits 206. Quantum circuits 206 may collectively or individually be referred to as quantum circuits 206 or quantum circuit 206, respectively. A “quantum circuit 206,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{jθX}, which corresponds to a rotation of the qubit state around the X-axis by the given angle theta θ on the Bloch sphere), RY (performs e^{jθY}, which corresponds to a rotation of the qubit state around the Y-axis by the given angle theta θ on the Bloch sphere), RXX (performs the operation e^{(-iθ/2X}^{_{⊕}}^{X)} on the input qubit), RZZ (takes in one input, an angle theta θ expressed in radians, and it acts on two qubits), etc. In one embodiment, quantum circuits 206 are written such that the horizontal axis is time, starting at the left hand side and ending at the right hand side.

Furthermore, in one embodiment, quantum circuit 206 corresponds to a command structure provided to control processor plane 204 on how to operate control and measurement plane 203 to run the algorithm on quantum data plane 202/quantum processor 113.

Furthermore, quantum computing device 106 includes memory 207, which may correspond to quantum memory. In one embodiment, memory 207 is a set of quantum bits that store quantum states for later retrieval. The state stored in quantum memory 207 can retain quantum superposition.

In one embodiment, memory 207 stores an application 208 that may be configured to implement one or more of the methods described herein in accordance with one or more embodiments. For example, application 208 may implement a program for handling black swan events on quantum computing device 106 as discussed below in connection with FIGS. 4-7. Examples of memory 207 include light quantum memory, solid quantum memory, gradient echo memory, electromagnetically induced transparency, etc.

Referring now to FIG. 3, in conjunction with FIG. 1, FIG. 3 illustrates an embodiment of the present disclosure of the hardware configuration of room temperature electronics system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (stored in block 301) involved in performing the inventive methods, such as handling black swan events on a quantum computing device. In addition to block 301, computing environment 300 includes, for example, room temperature electronics system 102, network 104, such as a wide area network (WAN), end user device (EUD) 302, remote server 303, public cloud 304, and private cloud 305. In this embodiment, room temperature electronics system 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Room temperature electronics system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically room temperature electronics system 102, to keep the presentation as simple as possible. Room temperature electronics system 102 may be located in a cloud, even though it is not shown in a cloud in FIG. 3. On the other hand, room temperature electronics system 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto room temperature electronics system 102 to cause a series of operational steps to be performed by processor set 306 of room temperature electronics system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of room temperature electronics system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In room temperature electronics system 102, the volatile memory 310 is located in a single package and is internal to room temperature electronics system 102, but, alternatively or additionally, the volatile memory may be distributed over multiple packages and/or located externally with respect to room temperature electronics system 102.

Persistent Storage 311 is any form of non-volatile storage for computers that is now known or to be developed in the future. The non-volatility of this storage means that the stored data is maintained regardless of whether power is being supplied to room temperature electronics system 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of room temperature electronics system 102. Data communication connections between the peripheral devices and the other components of room temperature electronics system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where room temperature electronics system 102 is required to have a large amount of storage (for example, where room temperature electronics system 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows room temperature electronics system 102 to communicate with other computers through WAN 104. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to room temperature electronics system 102 from an external computer or external storage device through a network adapter card or network interface included in network module 317.

WAN 104 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates room temperature electronics system 102), and may take any of the forms discussed above in connection with room temperature electronics system 102. EUD 302 typically receives helpful and useful data from the operations of room temperature electronics system 102. For example, in a hypothetical case where room temperature electronics system 102 is designed to provide a recommendation to an end user, this recommendation would typically be communicated from network module 317 of room temperature electronics system 102 through WAN 104 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to room temperature electronics system 102. Remote server 303 may be controlled and used by the same entity that operates room temperature electronics system 102. Remote server 303 represents the machine(s) that collect and store helpful and useful data for use by other computers, such as room temperature electronics system 102. For example, in a hypothetical case where room temperature electronics system 102 is designed and programmed to provide a recommendation based on historical data, then this historical data may be provided to room temperature electronics system 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 104 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components (e.g., black swan detection and handling module 110, sensor data collection module 115, etc.) discussed above in connection with FIG. 1 to handle black swan events on quantum computing device 106. In one embodiment, such components may be implemented in hardware. The functions discussed above performed by such components are not generic computer functions. As a result, room temperature electronics system 102 is a particular machine that is the result of implementing specific, non-generic computer functions.

In one embodiment, the functionality of such software components of room temperature electronics system 102, including the functionality for handling black swan events on quantum computing device 106, may be embodied in an application specific integrated circuit.

As stated above, NISQ algorithms are designed for quantum processors in the NISQ era, such as the variational quantum eigensolver (VQE) and quantum approximate optimization algorithm (QAOA). These algorithms have been explored in quantum chemistry, machine learning, and optimization and have potential applications in various fields including physics, material science, data science, cryptography, biology, and finance. However, they often require error mitigation or suppression techniques to produce accurate results. Examples of such error mitigation or suppression techniques include learning the noise fingerprint of quantum devices, learning the quantum noise, learning to optimize the quantum circuits in the presence of noise, using machine learning to reconstruct the noise spectrum and identify sources of error, etc. Unfortunately, such error mitigation and suppression techniques fail to dynamically handle black swan events. A “black swan event,” refers to external environmental conditions that may impact the operation and/or performance of the quantum computer. Examples of black swan events include vibrations from a data center computer room air condition unit, vibrations from other information technology equipment within a data center, audible sound vibrations from a fire alarm in the building, users accidentally bumping into the quantum computing system, pressure changes, temperature changes, humidity changes, solar flares, radiation events, etc. The duration of such black swan events may exceed by many orders of magnitude the typical gate or circuit time thereby impacting many quantum circuit executions. Unfortunately, there is not currently a means for handling such black swan events on a quantum computing device.

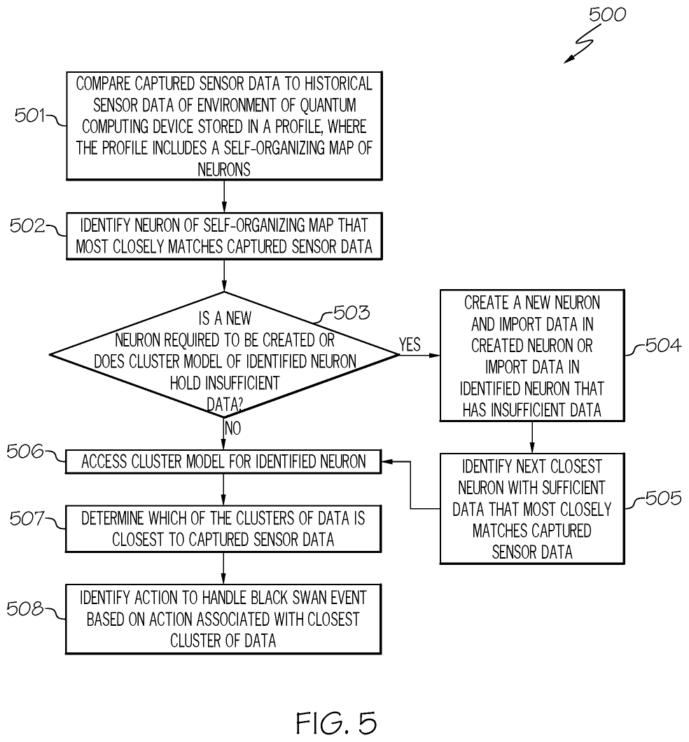

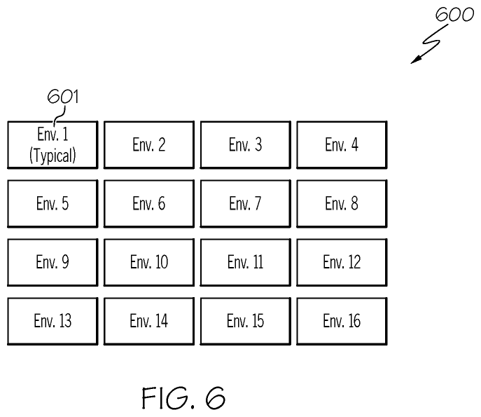

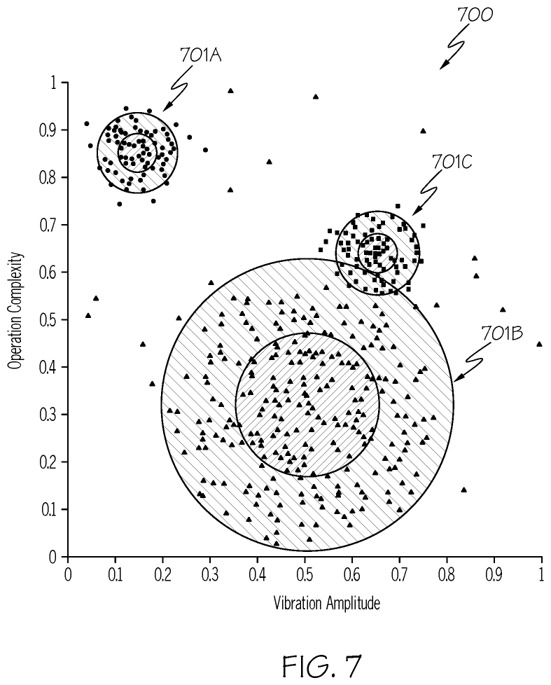

The embodiments of the present disclosure provide the means for handling such black swan events on a quantum computing device as discussed below in connection with FIGS. 4-7. FIG. 4 is a flowchart of a method for handling black swan events that occur during execution of the quantum processor. FIG. 5 is a flowchart of a method for identifying the action to be performed to handle the black swan event. FIG. 6 illustrates a self-organizing map of neurons, where each neuron represents environmental conditions experienced by the quantum computing device (e.g., quantum computing device 106 in physical environment 103). FIG. 7 illustrates a cluster model contained within a neuron of the self-organizing map of neurons.

As stated above, FIG. 4 is a flowchart of a method 400 for handling black swan events that occur during execution of the quantum processor (e.g., quantum processor 113) in accordance with an embodiment of the present disclosure.

Referring to FIG. 4, in conjunction with FIGS. 1-3, in step 401, sensor data collection module 115 of room temperature electronics system 102 captures sensor data from an environment of quantum computing device 106. In one embodiment, sensor data is obtained from environmental sensors 114 and captured by sensor data collection module 115 of temperature electronics system 102. Examples of sensor data include sound, pressure, temperature, humidity, vibration, and radiation.

In one embodiment, room temperature electronics system 102 and/or quantum computing device 106 includes such environmental sensors 114. As a result, in such an embodiment, sensor data collection module 115 captures sensor data from such sensors in room temperature electronics system 102 and/or quantum computing device 106.

As discussed above, environmental sensors 114 are used to monitor the environment around quantum computing device 106, including the environment around quantum processor 113. Such sensor data (e.g., pressure, temperature, humidity, etc.) pertaining to the environment around quantum computing device 106, including the environment around quantum processor 113, is later captured by sensor data collection module 115 of room temperature electronics system 102. In one embodiment, sensor data collection module 115 captures the sensor data from environmental sensors 114 using various software tools, including, but not limited to, Data Capture Lab, etc. Examples of environmental sensors 114 include, but are not limited to, microphones (e.g., Sennheiser® EW 112P G3-A), vibration sensors (e.g., DX-VBR by Raritan®), pressure sensors (e.g., differential air pressure sensor), temperature sensors (e.g., DX2-T1 by Raritan®), humidity sensors (e.g., DX2-T1H1 by Raritan®), radiation sensors (e.g., Reed R8008 radiation meter), etc.

In step 402, black swan detection and handling module 110 of room temperature electronics system 102 compares the captured sensor data to the historical sensor data of the environment of quantum computing device 106.

As discussed above, in one embodiment, quantum system environment profile 111 stores the historical sensor data of the environment of quantum computing device 106. For example, quantum system environment profile 111 stores the typical system vibration across a frequency range. In another example, quantum system environment profile 111 stores the typical sound profile across a frequency range. In a further example, quantum system environment profile 111 stores the typical radiation exposure. In one embodiment, such historical sensor data of the environment of quantum computing device 106 is stored in quantum system environment profile 111 by an expert based on environmental data captured by environmental sensors 114.

In one embodiment, such a comparison is performed using data and/or digital signal processing techniques used to convert the captured sensor data and/or historical sensor data of the environment of quantum computing device 106 to be in the same format. For example, the sensor data may be processed using data and/or digital processing techniques, such as converting sound or vibration data to the frequency domain using the Fourier transform to more easily compare amplitude and frequency components.

In another embodiment, such historical sensor data of the environment of quantum computing device 106 is stored in a profile, such as quantum system environment profile 111, where profile 111 includes a self-organizing map of neurons, where each of the neurons represents environmental conditions experienced within physical environment 103. That is, each of the neurons represents historical environmental conditions in the environment of quantum computing device 106. For example, one of the neurons may represent the historical environmental condition pertaining to pressure, such as the average amount of pressure in the environment of quantum computing device 106 for the day and time in question. Such historical environmental data in the neuron pertaining to pressure may then be compared with the captured sensor data pertaining to pressure. A further description and illustration of the self-organizing map of neurons is provided below.

In step 403, black swan detection and handling module 110 of room temperature electronics system 102 determines whether a black swan event is detected.

In one embodiment, black swan detection and handling module 110 determines if a black swan event transpired based on the difference between the captured sensor data (captured in step 401) and the historical sensor data (same type of sensor data as the captured sensor data) exceeding a threshold value, which may be user-specified. For example, a comparison may be made between the captured senor data pertaining to sound in the environment of quantum computing device 106 and the historical sensor data pertaining to sound in the environment of quantum computing device 106. If such a difference exceeds such a threshold value, then a black swan event may be said to occur. Otherwise, a black swan event may be said to not occur.

In one embodiment, such a threshold value is user-designated, which may vary based on the type of sensor data being compared. In one embodiment, such threshold values for the various types of sensor data being compared are stored in a data structure (e.g., table), which may be stored in a storage device (e.g., storage device 311, 315) of room temperature electronics system 102. For example, a first threshold value may be specified for sound sensor data and a second threshold value may be specified for pressure sensor data. In one embodiment, such threshold values are populated in the data structure by an expert.

In one embodiment, a black swan event is detected based on comparing the captured sensor data from the environment of quantum computing device 106 with the historical sensor data stored in the self-organizing map of neurons, where each of the neurons represents environmental conditions experienced within physical environment 103. In one embodiment, black swan detection and handling module 110 compares the captured sensor data for a particular type of sensor data (e.g., pressure) with the neurons representing the historical environmental condition for the same type of sensor data (e.g., average amount of pressure in the environment of quantum computing device 106 for the day and time in question). If the difference between the value(s) of the captured sensor data for a particular type of sensor data (e.g., pressure) with the neurons representing the value(s) of the historical environmental condition for the same type of sensor data (e.g., pressure) exceeds a user-designated threshold value, then a black swan event may be said to occur. Otherwise, a black swan event may be said to not occur.

If a black swan event was deemed to not occur, then, in step 404, the classical black swan machine learning model 107 is updated to identify situations in which an action does not need to be performed since a black swan was deemed to not occur. In particular, in one embodiment, the neuron associated with such captured sensor data may be updated to reflect a situation in which an action does not need to be performed because the data comparison did not trigger a black swan event. A further discussion regarding training and updating classical black swan machine learning model 107 is provided below.

After updating classical black swan machine learning model 107, sensor data collection module 115 of room temperature electronics system 102 captures sensor data from an environment of quantum computing device 106 in step 401.

If a black swan event was deemed to occur, then, in step 405, black swan detection and handling module 110 of room temperature electronics system 102 determines whether quantum processor 113 was being utilized at the same time as the black swan event. In one embodiment, black swan detection and handling module 110 tracks the utilization of quantum processor 113, such as via a usage monitor, to determine if quantum processor 113 is being utilized at the time that the black swan event was detected. Examples of such a usage monitor include, but are not limited to, LabOne Q, etc.

If quantum processor 113 was not being utilized at the time that the black swan event was detected, then sensor data collection module 115 of room temperature electronics system 102 continues to captures sensor data from an environment of quantum computing device 106 in step 401.

If, however, quantum processor 113 is detected as being utilized at the same time as the black swan event, then, in step 406, black swan detection and handling module 110 of room temperature electronics system 102 determines the complexity of the quantum computation being performed at the time the black swan event was detected.

In one embodiment, complexity is determined based on the length of time to perform computations or the number of storage locations quantum processor 113 utilizes to perform computations. The greater the length of time to perform computations or the greater the number of storage locations utilized to perform computations, the more complex is the computation being performed by quantum processor 113 and vice-versa. In one embodiment, the length of time and number of storage locations utilized by quantum processor 113 is determined based on analysis tools, such as, but not limited to, QuCAT, QCircuits®, Qiskit®, etc. In one embodiment, different levels of complexity are based on different lengths of time and/or different number of storage locations, where such levels are determined by an expert. For example, the longer lengths of time are associate with higher levels of complexity than lower lengths of time. In one embodiment, such lengths and/or number of storage locations that determine the levels of complexity is stored in a data structure (e.g., table), which may be populated by an expert. In one embodiment, such a data structure is stored in a storage device (e.g., storage device 311, 315) of room temperature electronics system 102.

In one embodiment, complexity is determined based on the number of gate operations performed on a qubit, the level of entanglement of the qubit with one or more other qubits, or the required precision on the Bloch sphere for obtaining the desired outcome.

In step 407, black swan detection and handling module 110 of room temperature electronics system 102 executes the classical black swan machine learning model 107 to identify an action to be performed to handle the black swan event.

In one embodiment, the classical black swan machine learning model 107 utilizes various inputs, including, but not limited to, the captured sensor data (obtained from step 401), the difference between the captured sensor data of the environment of quantum computing device 106 and the historical sensor data of the environment of quantum computing device 106, complexity of the quantum computation being performed at the time the black swan event was detected, etc.

In one embodiment, the classical black swan machine learning model 107 is trained to predict the action to be performed to handle the black swan event based on various inputs, such as the captured sensor data, the difference between the captured sensor data of the environment of quantum computing device 106 and the historical sensor data of the environment of quantum computing device 106, complexity of the quantum computation being performed at the time the black swan event was detected, etc.

In one embodiment, a machine learning algorithm (e.g., supervised learning) is used to build the classical black swan machine learning model 107 to predict the action to be performed to handle the black swan event using a sample data set containing the captured sensor data, the difference between the captured sensor data of the environment of quantum computing device 106 and the historical sensor data of the environment of quantum computing device 106, complexity of the quantum computation being performed at the time the black swan event was detected, etc. and the action to be performed to handle the black swan event based on such inputs.

Such a sample data set is referred to herein as the “training data,” which is used by the machine learning algorithm to make predictions or decisions as to the predicted action to be performed to handle the black swan event based on the inputs discussed above. The algorithm iteratively makes predictions on the training data as to the action to be performed to handle the black swan event based on the inputs discussed above until the predictions achieve the desired accuracy as determined by an expert. Examples of such learning algorithms include nearest neighbor, Naïve Bayes, decision trees, linear regression, support vector machines and neural networks.

In one embodiment, the training data utilizes environmental data via the self-organizing map of neurons. As discussed above, a “self-organizing map,” as used herein, refers to an unsupervised machine learning technique used to produce a low-dimensional (typically two-dimensional) representation of a higher dimensional data set while preserving the topological structure of the data. In one embodiment, such a self-organizing map includes neurons or nodes, which are arranged as a hexagonal or rectangular grid with two dimensions. In one embodiment, each neuron represents an environmental condition experienced within the physical environment of the quantum computing device. Furthermore, in one embodiment, each neuron contains clusters of data, where each cluster of data is associated with an action in positively handling the black swan event. Additionally, in one embodiment, such clusters of data include the inputs discussed above, such as computational complexity, etc.

In one embodiment, classical black swan machine learning model 107 is trained to predict the action to be performed to handle the black swan event from such training data based on identifying the neuron that most closely matches the captured sensor data as well as identifying that cluster of data within that neuron that most closely matches the captured sensor data. An action to be performed to handle the black swan event is then identified by classical black swan machine learning model 107, where such an identified action corresponds to the action associated with the cluster of data that most closely matches the captured sensor data.

Furthermore, in one embodiment, based on user feedback regarding such actions, as discussed further below, the neurons are updated to reflect whether such an action was necessary or effective as a form of supervised learning thereby improving the predicted action to be performed, if at all, in handling the black swan event.

A further discussion regarding classical black swan machine learning model 107 identifying the action to be performed to handle the black swan event utilizing the self-organizing map of neurons is provided below in connection with FIG. 5.

FIG. 5 is a flowchart of a method 500 for identifying the action to be performed to handle the black swan event in accordance with an embodiment of the present disclosure.

Referring to FIG. 5, in conjunction with FIGS. 1-4, in step 501, black swan detection and handling module 110 of room temperature electronics system 102 compares the captured sensor data (captured in step 401 of FIG. 4) to the historical sensor data of the environment of quantum computing device 106 stored in profile 111, where profile 111 includes a self-organizing map of neurons as shown in FIG. 6.

Referring to FIG. 6, FIG. 6 illustrates a self-organizing map 600 of neurons 601, where each neuron 601 represents environmental conditions experienced by the quantum computing device (e.g., quantum computing device 106 in physical environment 103), in accordance with an embodiment of the present disclosure.

As shown in FIG. 6, self-organizing map 600 contains neurons 601 that represent the different environmental conditions that may be experienced by quantum computing device 106 in physical environment 103. While FIG. 6 illustrates 16 neurons 601, it is noted that self-organizing map may contain any number of neurons 601.

A “self-organizing map 600,” as used herein, refers to an unsupervised machine learning technique used to produce a low-dimensional (typically two-dimensional) representation of a higher dimensional data set while preserving the topological structure of the data. In one embodiment, such a self-organizing map includes neurons 601 or nodes, which are arranged as a hexagonal or rectangular grid with two dimensions as shown in FIG. 6.

In one embodiment, each neuron 601 represents an environmental condition of quantum computing device 106 in physical environment 103. For example, neuron 601 for environment 1 (“Env 1”) may contain the typical sensor readings, such as typical sensor readings for sound. Neurons 601 for environments 2-8 (“Env 2” . . . “Env 8”) may represent vibration conditions with different dominant frequencies. Neurons 601 for environments 9-12 (“Env 9” . . . “Env 12”) may represent audible sounds with differing dominant frequencies. Neurons 601 for environments 13-16 (“Env 13” . . . “Env 16”) may represent different radiation levels from solar flares. Although a single sensor reading is described for simplicity, neurons 601 may exist that represent a plurality of sensor readings all occurring simultaneously. For example, a first neuron 601 may exist for a specific vibration frequency in an environment that is within a specified temperature range and a second neuron 601 may exist for the same vibration frequency but in a different temperature range.

Returning to FIG. 5, in conjunction with FIGS. 1-4 and 6, in step 502, black swan detection and handling module 110 of room temperature electronics system 102 identifies neuron 601 from self-organizing map 600 that most closely matches the captured sensor data (captured in step 401 of FIG. 4). In performing such a determination, in one embodiment, black swan detection and handling module 110 first determines the type of sensor data (e.g., vibration) that was captured that triggered the black swan event at step 403 and then examines neurons 601 for environments which represent such sensor data. For example, if the captured sensor data pertains to vibration, then black swan detection and handling module 110 examines neurons 601 for environments 2-8 which represent vibration conditions with different dominant frequencies. In one embodiment, the particular environment conditions represented by each neuron 601 is stored in a data structure (e.g., table), which may be populated by an expert. In this manner, black swan detection and handling module 110 identifies which neurons 601 represent similar sensor data as the captured sensor data. In one embodiment, such a data structure is stored in a storage device (e.g., storage device 311, 315) of room temperature electronics system 102.

In one embodiment, the captured sensor data (captured in step 401) is compared with the sensor data contained in neurons 601. In one embodiment, such a comparison pertains to the similarity between the data (captured sensor data and the sensor data contained in neurons 601). In one embodiment, the similarity is determined by computing the Jaccard similarity coefficient (or index). For example, for two sets of data, A and B, the Jaccard index is defined to be the ratio of the size of their intersection and the size of their union: J(A,B)=(A∩B)/(A∪B). The sensor data of neuron 601 that has the highest Jaccard similarity coefficient with the captured sensor data corresponds to the mostly closely matched neuron 601.

In another embodiment, black swan detection and handling module 110 of room temperature electronics system 102 determines the similarity between the data (captured sensor data and the sensor data contained in neurons 601) using the MinHash scheme to estimate J(A,B) quickly without computing the intersection or union. In one embodiment, the following aggregate functions are utilized by black swan detection and handling module 110 for estimating the approximate similarity using MinHash: MINHASH (returns a MinHash state containing a MinHash array of length k (input argument), MINHASH COMBINE (combines two (or more) input MinHash states into a single output MinHash state) and APPROXIMATE SIMILARITY (returns an estimation of the similarity (Jaccard index) of input sets based on their MinHash states). The sensor data of neuron 601 that has the highest estimated Jaccard similarity coefficient with the captured sensor data corresponds to the mostly closely matched neuron 601.

In one embodiment, black swan detection and handling module 110 of room temperature electronics system 102 determines the similarity between the data (captured sensor data and the sensor data contained in the neurons 601) by encoding the data and then calculating the cosine similarity of the resulting two embeddings.

In one embodiment, black swan detection and handling module 110 generates a score as a result of calculating the similarity between the data. In one embodiment the higher the score, the greater the similarity between the data (captured sensor data and the sensor data contained in neurons 601). In one embodiment, such a score is normalized between 0 and 1. In one embodiment, black swan detection and handling module 110 applies a natural language processing algorithm to calculate the semantic similarity between the data which results in a score using word embedding techniques, such as Word2Vec and TF-IDF. In one embodiment, the sensor data of neuron 601 that has the highest score with the captured sensor data corresponds to the mostly closely matched neuron 601.

Based on such scores discussed above, such as the Jaccard similarity coefficient, black swan detection and handling module 110 determines whether the identified neuron 601 has insufficient data held within the cluster model of the identified neuron 601 or whether a new neuron 601 needs to be created. In one embodiment, such a determination is based on a range of scores. For instance, scores between 0.6 and 0.8 may indicate that the identified neuron 601 has insufficient data held within the cluster model of the identified neuron 601. Scores that are less than 0.6 indicate that a new neuron 601 needs to be created.

In one embodiment, black swan detection and handling module 110 determines that a new neuron 601 needs to be created if the Euclidean distance between the data points of the selected neuron 601 and the captured sensor data exceeds a threshold value, which may be user-designated.

In one embodiment, black swan detection and handling module 110 determines that insufficient data exists within the cluster model of the identified neuron 601 based on the number of data points within neuron 601 being less than a threshold value, which may be user-designated.

The “cluster model,” as used herein, refers to a model for categorizing data into a certain number of clusters or groups as shown in FIG. 7.

Referring to FIG. 7, FIG. 7 illustrates a cluster model 700 contained within a neuron 601 of self-organizing map 600 of neurons 601 in accordance with an embodiment of the present disclosure.

As shown in FIG. 7, cluster model 700 for a specific neuron 601 reflects a grouping of clusters 701A-701C of data. For example, cluster model 700 may be for a specific neuron 601 that reflects a grouping of dominant vibrational frequencies that occur together (e.g., vibrations from a data center computer room air conditioning unit). Clusters 701A-701C may collectively or individually be referred to as clusters 701 or cluster 701, respectively. While FIG. 7 illustrates cluster model 700 containing three clusters 701, cluster model 700 may contain any number of clusters 701.

Furthermore, the illustrated cluster model 700 of FIG. 7 shows a graph with an axis of vibrational amplitude (vibrational frequencies are already known based on the selected neuron 601) and operation complexity (obtained from step 406 of FIG. 4). In one embodiment, the captured sensor data may be plotted to determine which of the clusters 701 of data within cluster model 700 is closest to the captured sensor data.

In one embodiment, each cluster, such as clusters 701A-701C of cluster model 700, is associated with an action in positively handling the black swan event. Actions for handling the black swan event include, but are not limited to, dynamically increasing the number of shots performed on a current operation, pausing the current operation and waiting for the black swan event to end, repeating the latest operation or set of operations, dynamically adjusting the quantum circuits to shorten their depth, executing a different quantum model, etc.

In one embodiment, cluster model 700 may include hierarchical clusters 701 to allow for more granular classification.

In one embodiment, such clustering of clusters 701 within cluster model 700 is accomplished via k-means clustering.

Returning to FIG. 5, in conjunction with FIGS. 1-4 and 6-7, in step 503, black swan detection and handling module 110 of room temperature electronics system 102 determines whether a new neuron 601 is required to be created or whether cluster model 700 of the identified neuron 601 of step 502 holds insufficient data.

As discussed above, in one embodiment, black swan detection and handling module 110 determines that a new neuron 601 needs to be created if the Euclidean distance between the data points of the selected neuron 601 and the captured sensor data exceeds a threshold value, which may be user-designated. In one embodiment, black swan detection and handling module 110 determines that insufficient data exists within cluster model 700 of the identified neuron 601 based on the number of data points within neuron 601 being less than a threshold value, which may be user-designated.

If a new neuron 601 needs to be created or cluster model 700 of the identified neuron 601 of step 502 holds insufficient data, then, in step 504, black swan detection and handling module 110 of room temperature electronics system 102 creates a new neuron 601 and imports data in the created neuron 601 or imports data in the identified neuron 601 that has insufficient data, respectively.

In one embodiment, such imported sensor data corresponds to the sensor data that was captured in step 401 of FIG. 4. In one embodiment, only a portion of the captured sensor data is imported, such as randomly selecting the number of data points that neuron 601 lacks before neuron 601 is deemed to contain a sufficient amount of data points. In one embodiment, when a neuron 601 is created, a random number of data points is selected from the captured sensor data that corresponds to the required number of data points that a neuron 601 is required to contain in order to be deemed to contain a sufficient amount of data points.

Upon creating a new neuron 601 and importing data in the created neuron or importing data in the identified neuron 601 that has insufficient data, in step 505, black swan detection and handling module 110 identifies the next closest neuron 601 with sufficient data that most closely matches the captured sensor data using the same process as discussed above in step 502.

If a new neuron 601 does not need to be created and the cluster model 700 of the identified neuron 601 of step 502 holds sufficient data or upon identifying the next closest neuron 601 with sufficient data that most closely matches the captured sensor data in step 505, then, in step 506, black swan detection and handling module 110 of room temperature electronics system 102 accesses cluster model 700 for the identified neuron 601 as discussed above in connection with FIG. 7.

In step 507, black swan detection and handling module 110 of room temperature electronics system 102 determines which of the clusters 701 of data within cluster model 700 for the identified neuron 601 is closest to the captured sensor data (captured in step 401).

As discussed above, in one embodiment, the captured sensor data is plotted within cluster model 700 to determine which of the clusters 701 of data within cluster model 700 is closest to the captured sensor data.

In step 508, black swan detection and handling module 110 of room temperature electronics system 102 identifies the action to handle the black swan event based on the action associated with the closest cluster of data.

As discussed above, in one embodiment, each cluster, such as clusters 701A-701C of cluster model 700, is associated with an action in positively handling the black swan event. Actions for handling the black swan event include, but are not limited to, dynamically increasing the number of shots performed on a current operation, pausing the current operation and waiting for the black swan event to end, repeating the latest operation or set of operations, dynamically adjusting quantum circuits to shorten their depth, executing a different quantum model, etc. Based on identifying cluster 701 (e.g., cluster 701A) that is closest to the captured sensor data, the action associated with such an identified cluster 701 is then identified as corresponding to the action to be used to handle the black swan event.

Returning to step 407 of FIG. 4, in conjunction with FIGS. 1-3 and 5-7, classical black swan machine learning model 107 is executed to identify the action to be performed to handle the black swan event using method 500

In step 408, black swan detection and handling module 110 of room temperature electronics system 102 performs the action identified by classical black swan machine learning model 107 to handle the black swan event.

An example of an action to handle the black swan event is to dynamically increase the number of shots performed on the current operation.

Another example of an action to handle the black swan event is to pause the current complex operation and/or important operation and wait for the black swan event to end. For example, if the operation is paused and the output of classical black swan machine learning model 107 indicates that the black swan event is likely to last for a longer duration of time (e.g., seconds, minutes), a less complex operation or an operation of lesser importance may be performed during this time.

A further example of an action to be performed to handle the black swan event is to repeat the latest operation or set of operations.

Another example of an action to be performed to handle the black swan event is to dynamically adjust the quantum circuits to shorten their depth and apply circuit knitting if coherence times dropped.

A further example of an action to be performed to handle the black swan event is to execute a different model designed to operate during the black swan event. For example, developers may have created a second model that performs the same operation but was designed to operate during the black swan event, such as including additional qubits and/or zero noise extrapolation.

In step 409, black swan detection and handling module 110 of room temperature electronics system 102 receives feedback regarding the identified action performed to handle the black swan event.

In one embodiment, such feedback may be provided by the user of computing device 101, such as via quantum system interaction user interface 105.

Upon receiving user feedback, black swan detection and handling module 110 of room temperature electronics system 102 updates classical black swan machine learning model 107 in step 404.

In one embodiment, such feedback is used for supervised training of classical black swan machine learning model 107. For example, classical black swan machine learning model 107 is updated to identify situations in which the predicted action to handle the black swan event was approved or disapproved by the user. In particular, in one embodiment, the identified neuron (identified in step 502) is updated to identify situations in which the predicted action to handle the black swan event was approved or disapproved by the user.

In one embodiment, such feedback is used to update classical black swan machine learning model 107 by updating the training data, which is used by the machine learning algorithm (supervised learning) to further train classical black swan machine learning model 107.

In this manner, black swan events that occur during the execution of the quantum processor are handled.

Furthermore, the principles of the present disclosure improve the technology or technical field involving noisy intermediate-scale quantum (NISQ) devices. As discussed above, NISQ algorithms are designed for quantum processors in the NISQ era, such as the variational quantum eigensolver (VQE) and quantum approximate optimization algorithm (QAOA). These algorithms have been explored in quantum chemistry, machine learning, and optimization and have potential applications in various fields including physics, material science, data science, cryptography, biology, and finance. However, they often require error mitigation or suppression techniques to produce accurate results. Examples of such error mitigation or suppression techniques include learning the noise fingerprint of quantum devices, learning the quantum noise, learning to optimize the quantum circuits in the presence of noise, using machine learning to reconstruct the noise spectrum and identify sources of error, etc. Unfortunately, such error mitigation and suppression techniques fail to dynamically handle black swan events. A “black swan event,” refers to external environmental conditions that may impact the operation and/or performance of the quantum computer. Examples of black swan events include vibrations from a data center computer room air condition unit, vibrations from other information technology equipment within a data center, audible sound vibrations from a fire alarm in the building, users accidentally bumping into the quantum computing system, pressure changes, temperature changes, humidity changes, solar flares, radiation events, etc. The duration of such black swan events may exceed by many orders of magnitude the typical gate or circuit time thereby impacting many quantum circuit executions. Unfortunately, there is not currently a means for handling such black swan events on a quantum computing device.

Embodiments of the present disclosure improve such technology by capturing sensor data (e.g., sound, pressure, temperature, humidity, vibration, radiation, etc.) from an environment of the quantum computing device and comparing such captured sensor data to historical sensor data of the environment of the quantum computing device. In one embodiment, a black swan event is detected based on comparing the captured sensor data from the environment of the quantum computing device with the historical sensor data stored in a self-organizing map of neurons, where each of the neurons represents environmental conditions experienced within the physical environment of the quantum computing device. A “self-organizing map,” as used herein, refers to an unsupervised machine learning technique used to produce a low-dimensional (typically two-dimensional) representation of a higher dimensional data set while preserving the topological structure of the data. In one embodiment, such a self-organizing map includes neurons or nodes, which are arranged as a hexagonal or rectangular grid with two dimensions. If the difference between the value(s) of the captured sensor data for a particular type of sensor data (e.g., pressure) with the neuron representing the value(s) of the historical environmental condition for the same type of sensor data (e.g., pressure) exceeds a user-designated threshold value, then a black swan event may be said to occur. Upon detecting a black swan event, such as during the time that the quantum processor is being utilized, a machine learning model (referred to herein as the “classical black swan machine learning model”) is executed to identify the action to be performed to handle the black swan event. In one embodiment, the classical black swan machine learning model identifies the action to be performed to handle the black swan event based on identifying a neuron of the self-organizing map that most closely matches the captured sensor data, and then identifying which of the clusters of data within the neuron is closest to the captured sensor data. In one embodiment, each neuron contains clusters of data, where each cluster of data is associated with an action in positively handling the black swan event. After identifying the cluster of data that is closest to the captured sensor data, an action to handle the black swan event is performed based on the action associated with the closest cluster of data. In this manner, black swan events involving quantum computing devices can be effectively handled. Furthermore, in this manner, there is an improvement in the technical field involving noisy intermediate-scale quantum (NISQ) devices.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a method for handling black swan events on a quantum computing device comprises capturing sensor data from an environment of the quantum computing device. The method further comprises comparing the captured sensor data to historical sensor data of the environment of the quantum computing device. The method additionally comprises detecting a black swan event in response to a difference between the captured sensor data and the historical sensor data exceeding a threshold value. Furthermore, the method comprises performing an action to handle the black swan event.

Additionally, in one embodiment of the present disclosure, the action comprises one of the following in the group consisting of dynamically increasing a number of shots performed on a current operation, pausing the current operation and waiting for the black swan event to end, repeating a latest operation or a set of operations, dynamically adjusting quantum circuits to shorten their depth, and executing a different quantum model.

Furthermore, in one embodiment of the present disclosure, the method additionally comprises comparing the captured sensor data to the historical sensor data of the environment of the quantum computing device stored in a profile, where the profile comprises a self-organizing map of neurons, and where each of the neurons represents environmental conditions experienced within a physical environment.

Additionally, in one embodiment of the present disclosure, each of the neurons contains clusters of data, where each of the clusters of data is associated with an action in positively handling the black swan event, and where the method further comprises identifying a neuron of the neurons of the self-organizing map of neurons that most closely matches the captured sensor data. Furthermore, the method comprises determining which of the clusters of data of the identified neuron is closest to the captured sensor data. Additionally, the method comprises performing the action to handle the black swan event based on an action associated with the closest cluster of data.

Furthermore, in one embodiment of the present disclosure, the sensor data comprises one of the following in the group consisting of sound, pressure, temperature, humidity, vibration, and radiation.

Additionally, in one embodiment of the present disclosure, the method further comprises determining whether a quantum processor was being utilized at a same time as the black swan event. Furthermore, the method comprises executing a machine learning model to identify the action to be performed to handle the black swan event in response to the quantum processor being utilized at the same time as the black swan event. Additionally, the method comprises receiving user feedback regarding the identified action to be performed to handle the black swan event. In addition, the method comprises updating the machine learning model based on the received user feedback.

Furthermore, in one embodiment of the present disclosure, the black swan event comprises one or more of the following in the group consisting of vibrations, sounds, pressure changes, temperature changes, humidity changes, solar flares, and radiation events.

Other forms of the embodiments of the method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for handling black swan events on a quantum computing device, the method comprising:
capturing sensor data from an environment of said quantum computing device;
comparing said captured sensor data to historical sensor data of said environment of said quantum computing device;
detecting a black swan event in response to a difference between said captured sensor data and said historical sensor data exceeding a threshold value; and
performing an action to handle said black swan event.

2. The method as recited in claim 1, wherein said action comprises one of the following in the group consisting of dynamically increasing a number of shots performed on a current operation, pausing said current operation and waiting for said black swan event to end, repeating a latest operation or a set of operations, dynamically adjusting quantum circuits to shorten their depth, and executing a different quantum model.

3. The method as recited in claim 1 further comprising:
comparing said captured sensor data to said historical sensor data of said environment of said quantum computing device stored in a profile, wherein said profile comprises a self-organizing map of neurons, wherein each of said neurons represents environmental conditions experienced within a physical environment.

4. The method as recited in claim 3, wherein each of said neurons contains clusters of data, wherein each of said clusters of data is associated with an action in positively handling said black swan event, wherein the method further comprises:
identifying a neuron of said neurons of said self-organizing map of neurons that most closely matches said captured sensor data;
determining which of said clusters of data of said identified neuron is closest to said captured sensor data; and
performing said action to handle said black swan event based on an action associated with said closest cluster of data.

5. The method as recited in claim 1, wherein said sensor data comprises one of the following in the group consisting of sound, pressure, temperature, humidity, vibration, and radiation.

6. The method as recited in claim 1 further comprising:
determining whether a quantum processor was being utilized at a same time as said black swan event;
executing a machine learning model to identify said action to be performed to handle said black swan event in response to said quantum processor being utilized at said same time as said black swan event;
receiving user feedback regarding said identified action to be performed to handle said black swan event; and
updating said machine learning model based on said received user feedback.

7. The method as recited in claim 1, wherein said black swan event comprises one or more of the following in the group consisting of vibrations, sounds, pressure changes, temperature changes, humidity changes, solar flares, and radiation events.

8. A computer program product for handling black swan events on a quantum computing device, the computer program product comprising one or more computer readable storage mediums having program code embodied therewith, the program code comprising programming instructions for:
capturing sensor data from an environment of said quantum computing device;
comparing said captured sensor data to historical sensor data of said environment of said quantum computing device;
detecting a black swan event in response to a difference between said captured sensor data and said historical sensor data exceeding a threshold value; and
performing an action to handle said black swan event.

9. The computer program product as recited in claim 8, wherein said action comprises one of the following in the group consisting of dynamically increasing a number of shots performed on a current operation, pausing said current operation and waiting for said black swan event to end, repeating a latest operation or a set of operations, dynamically adjusting quantum circuits to shorten their depth, and executing a different quantum model.

10. The computer program product as recited in claim 8, wherein the program code further comprises the programming instructions for:
comparing said captured sensor data to said historical sensor data of said environment of said quantum computing device stored in a profile, wherein said profile comprises a self-organizing map of neurons, wherein each of said neurons represents environmental conditions experienced within a physical environment.

11. The computer program product as recited in claim 10, wherein each of said neurons contains clusters of data, wherein each of said clusters of data is associated with an action in positively handling said black swan event, wherein the program code further comprises the programming instructions for:
identifying a neuron of said neurons of said self-organizing map of neurons that most closely matches said captured sensor data;
determining which of said clusters of data of said identified neuron is closest to said captured sensor data; and
performing said action to handle said black swan event based on an action associated with said closest cluster of data.

12. The computer program product as recited in claim 8, wherein said sensor data comprises one of the following in the group consisting of sound, pressure, temperature, humidity, vibration, and radiation.

13. The computer program product as recited in claim 8, wherein the program code further comprises the programming instructions for:
determining whether a quantum processor was being utilized at a same time as said black swan event;
executing a machine learning model to identify said action to be performed to handle said black swan event in response to said quantum processor being utilized at said same time as said black swan event;
receiving user feedback regarding said identified action to be performed to handle said black swan event; and
updating said machine learning model based on said received user feedback.

14. The computer program product as recited in claim 8, wherein said black swan event comprises one or more of the following in the group consisting of vibrations, sounds, pressure changes, temperature changes, humidity changes, solar flares, and radiation events.

15. A system, comprising:
a memory for storing a computer program for handling black swan events on a quantum computing device; and
a processor connected to said memory, wherein said processor is configured to execute program instructions of the computer program comprising:
capturing sensor data from an environment of said quantum computing device;
comparing said captured sensor data to historical sensor data of said environment of said quantum computing device;
detecting a black swan event in response to a difference between said captured sensor data and said historical sensor data exceeding a threshold value; and
performing an action to handle said black swan event.

16. The system as recited in claim 15, wherein said action comprises one of the following in the group consisting of dynamically increasing a number of shots performed on a current operation, pausing said current operation and waiting for said black swan event to end, repeating a latest operation or a set of operations, dynamically adjusting quantum circuits to shorten their depth, and executing a different quantum model.

17. The system as recited in claim 15, wherein the program instructions of the computer program further comprise:
comparing said captured sensor data to said historical sensor data of said environment of said quantum computing device stored in a profile, wherein said profile comprises a self-organizing map of neurons, wherein each of said neurons represents environmental conditions experienced within a physical environment.

18. The system as recited in claim 17, wherein each of said neurons contains clusters of data, wherein each of said clusters of data is associated with an action in positively handling said black swan event, wherein the program instructions of the computer program further comprise:
identifying a neuron of said neurons of said self-organizing map of neurons that most closely matches said captured sensor data;
determining which of said clusters of data of said identified neuron is closest to said captured sensor data; and
performing said action to handle said black swan event based on an action associated with said closest cluster of data.

19. The system as recited in claim 15, wherein said sensor data comprises one of the following in the group consisting of sound, pressure, temperature, humidity, vibration, and radiation.

20. The system as recited in claim 15, wherein the program instructions of the computer program further comprise:
determining whether a quantum processor was being utilized at a same time as said black swan event;
executing a machine learning model to identify said action to be performed to handle said black swan event in response to said quantum processor being utilized at said same time as said black swan event;
receiving user feedback regarding said identified action to be performed to handle said black swan event; and
updating said machine learning model based on said received user feedback.
